(19) United States
(12) Patent Application Publication
(10) Pub. No.: US 2011/0280258 A1
(43) Pub. Date: Nov. 17, 2011

(54) SYSTEM AND METHOD FOR DYNAMIC CONFIGURATION OF SESSION LAYER RETRY LOGIC BASED ON SIGNAL QUALITY

(75) Inventor: Mike Klingen, Phoenix, AZ (US)

(73) Assignee: APPSWARE WIRELESS, LLC, Scottsdale, AZ (US)

(21) Appl. No.: 12/781,660

(22) Filed: May 17, 2010

(51) Int. Cl. H04J 3/16

(52) U.S. Cl. 370/437

(57) ABSTRACT

The present invention involves the dynamic modification of network connection parameters based on signal conditions, and specifically, based on signal Quality of Service (QoS) measurements. Specifically, the disclosed systems and methods enable a remote communications terminal to best ensure a reliable wireless connection to a transaction-processing gateway in order to send and receive data packets relating to merchant transactions. The communications terminal is configurable, allowing a user to define threshold values that serve as triggering events for modifying and/or implementing a change to policies governing network connection attempts.

### FIELD OF THE INVENTION

This invention relates generally to a method and system for a dynamic configuration of signal transmission attempts within a wireless networking environment. More specifically, the present invention may be incorporated within a cellular-based transaction terminal, which is configured to transmit a transaction request to a processor, and further configured to receive an authorization message from the processor.

### BACKGROUND

Cellular telephone technology has had a dramatic impact on global commerce. Not only are business deals struck without regard to the physical locations of the parties involved, but funds are wirelessly transferred between the bank accounts of entities. Payment transactions that previously required access to a telephone line or other physical network connection now require little more than a mobile telephone or an Internet enabled wireless device.

With increased cellular network coverage and faster network speeds, remote card-based transactions are becoming more common within commerce-based industries. However, drawbacks remain that can hinder efficient and cost effective wireless transaction authorization. For example, Radio Frequency (RF) signal strength is not available in sufficient strength in all locations at all times. In contrast, RF signal strength may be of sufficient strength but lack the clarity required for data transmission. Signal “noise” may be introduced by any number of variables, thereby causing the signal to be unusable even when signal strength is optimal. Such variables may include natural conditions such as terrain and weather. Signal noise has other causes such as buildings, electrical interference, or interference from competing signals.

Because of variations in network Quality of Service (QoS) (i.e., strength and noise), many existing wireless transaction terminals include various schemes that are intended to best ensure that a two-way communication channel can be established between the terminal and a processor. A basic example of such a scheme includes logic that causes the terminal to invoke “retry” attempts at regular intervals. Simply put, the terminal determines whether an RF signal is accessible and attempts to establish a connection with a server via the available signal. If a signal and/or connection cannot be obtained, then the terminal times out, waits for a predetermined amount of time, and again attempts to establish a signal connection. This process may repeat for a finite amount of time and/or number of retry attempts before generating an error message.

Some terminals include more complex logic for establishing a wireless connection with a processing server. Those of ordinary skill in the art will appreciate that a connection between a “terminal and server”, as used herein, may include any number of intermediaries including, for example, mobile devices, base stations, relay stations, network routers, gateways, and the like.

Wire wireless terminals are typically equipped with a sensor and integrated software for determining RF signal strength. In addition to more complex tasks, the integrated software enables the mobile device to visually display the strength of the network to the user (e.g., as a series of “bars”). However, signal strength is only one factor that will determine whether a transaction may be successfully executed by way of a wireless network.

As will be appreciated by those of skill in the art, wireless transactions face several QoS challenges that are not found in wired communications. As stated above, the quality of a wireless link can change according to environmental factors, movements of the communications terminal, or movement of objects within the path between the wireless terminal, radio tower, and/or the base station. As such, certain QoS issues remain despite advances in wireless technology. For example, transport control protocol (TCP) packets employ a time-based fail check strategy, wherein packets that are not acknowledged as received are continually resent according to a predefined time period, the spacing between each delivery attempt increasing gradually. After a certain number of retries, the connection is deemed to have failed. While this strategy can be effective, it is not as suitable for packet delivery over wireless links that are susceptible connectivity instability.

In an environment where RF reception and transmission conditions are influenced by noise, interference, and attenuation, the process for establishing a quality link connection may require multiple attempts, time between attempts, or a modification of connection protocols. However, prior art systems do not dynamically address specific reception variables that are unique to the time and environment from which a signal connection originates. This can lead to excessive retry attempts within a relatively small amount of time, for example, resulting in excess power consumption and network usage costs. Therefore, a need exists for a system and method for optimizing network access attempts and/or parameters in light of real-time QoS for a wireless link connection. Specifically, there is a need for a system that is able to perform dynamic configuration of signal connection and data packet send/receive operations based on real-time variables in signal quality.

### SUMMARY OF THE INVENTION

In general, the present invention overcomes the limitations and problems of the prior art by providing a system and method for facilitating transaction retry attempts based on network QoS. The present invention incorporates a combination of hardware and/or software components configured to determine QoS, modify broadcasting and/or reception parameters, modify automated transmission retry events, modify network protocols, and the like.

Specifically, the invention seeks to optimize network access attempts based on network signal strength (field strength) for a transaction-based system. Such transaction based systems include, for example, a wireless Point of Sale (POS) terminal capable of receiving payment device data, configuring the data to a format suitable for transmission to a server, acquiring a transmission signal for network, determining if the strength of the signal is sufficient to transmit the data over the network, broadcasting the data over the network to the server when the signal strength is sufficient, and receiving processing data from the server over the network. The disclosed communications terminal is configured to determine the magnitude of an electric field at a reference point that is a significant distance from the transmitting antenna. In conjunction with the variously disclosed hardware and software components, the system enables the POS terminal to manage transmission attempts in order to ensure that the transmission occurs at the earliest moment of signal optimization. In other words, the invention enables a communications terminal to transmit transaction data over a wireless network such as, for example, a cellular network only when it is known that the network is accessible at a quality sufficient to reliably transmit the data to a processing gateway.

The above functionality of the disclosed system and method is accomplished by a communications terminal that includes a means for determining a connection Quality of Service (QoS) value and a memory structure for maintaining variables defining QoS threshold values, time intervals between connection attempts, preferred networking protocols, and signal frequency modulation settings. More specifically the variables instruct the communications terminal to dynamically modify network connection rules and parameters in response to real-time network conditions that may affect the success or failure of a transaction authorization request.

### BRIEF DESCRIPTION OF EXEMPLARY DRAWINGS

A more complete understanding of the present invention may be derived by referring to the detailed description and claims when considered in connection with the Figures, wherein like reference numbers refer to similar elements throughout the Figures, and:

FIG. 1 illustrates a high-level view of the various system components for facilitating transaction processing according to the dynamically adjusted connection retry logic in accordance with an exemplary embodiment of the present invention; and

FIG. 2 illustrates an exemplary schematic overview of the communications terminal including connection retry logic in accordance with an exemplary embodiment of the present invention.

### DETAILED DESCRIPTION OF EXEMPLARY EMBODIMENTS

In general, the present invention dynamically configures retry logic within a communications terminal using a broadcast signal to communicate with a processing gateway. The subsequent description of the invention includes both the description of the Retry Object of the communications terminal, as well as the overall system architecture elements, such as a Secure Gateway and Session Initiation Protocol (SIP) Server as necessary, such that one of ordinary skill in the art will appreciate the present invention in full. However, it should be understood that such illustration of the communications terminal in relation to various servers, databases, and networks does not limit the scope of the invention.

In an exemplary embodiment, the system interrogates a network to determine network signal quality of service (QoS) for any one or more accessible signals. A configurable Retry Object that resides within the Session Layer of the communications terminal determines whether a signal meets a threshold value. The threshold value may be defined according to any means known in the art for determining whether a link signal is optimal for sending and receiving transaction authorization data. For example, a transaction comprising a minimal transfer of data may require a signal of minimal bandwidth. Accordingly, the communications terminal may classify the transmission type and determine whether the available network signal meets minimal requirements for sending the transaction data. Similarly, the communications terminal may determine whether an adequate signal exists in light of a multi-dimensional analysis of the authorization request. For example, a received authorization request may include a merchant identifier, credit card number, Bank Identification Number (BIN), security code, cardholder identifier, etc. The data received in response to the authorization request may comprise a simple authorization code only. As such, the outgoing transmission may require a high QoS, while the receiving transmission may require a very minimal QoS value. The communications terminal may be configured to determine whether the QoS value is sufficient for both the outgoing and incoming transmissions.

As used herein, QoS refers to a measure of network performance that denotes the network's transmission quality and service availability. QoS can come in the form of traffic policy in which the transmission rates are limited; thereby guaranteeing a certain amount of bandwidth will be available to applications running at the communications terminal. Moreover, QoS may take the form of traffic shaping, which are techniques to reserve bandwidth for applications but not guarantee its availability.

In one embodiment, as will be discussed in greater detail herein, the present system and method enables one of ordinary skill in the art to interact with a wireless communications terminal in order to facilitate commerce at a remote location. Furthermore, the invention provides a more economic means for execution of wireless transactions, where variances in network QoS exist. However, the invention anticipates many uses beyond that which is disclosed. For example, while the invention is primarily described in relation to a cellular network, other types of networks are contemplated. The present systems and methods may be similarly applied to any transaction-based application where signals are to be transmitted over a network. This may include both wireless and wireline networks.

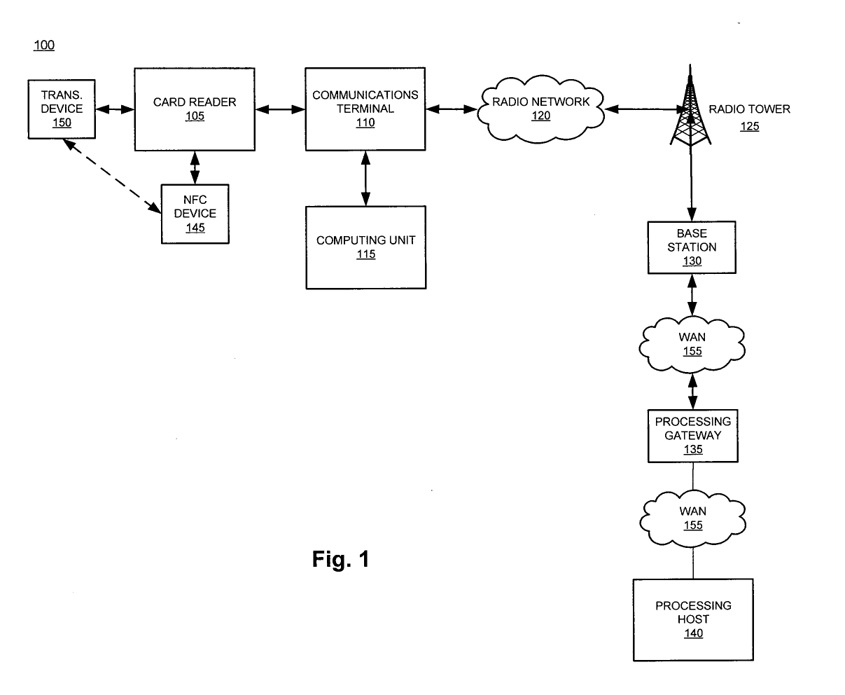

With reference to FIG. 1, core components of the system are presented to allow those of ordinary skill in the art to appreciate the scope of the invention and to provide a basis for understanding the core functionality and objectives of the invention. However, is should be understood that any number of configurations, combinations of components, use of existing components, and custom components may be arranged in order to facilitate the objectives of the present invention.

As used herein, a “communications terminal” 110 may comprise any hardware, software, or combination thereof configured to invoke and manage the disclosed transactions. More specifically, it should be noted that the communications terminal 110 may be embodied as any combination of hardware and/or software components configured to interact with various other hardware and/or software components in facilitating the disclosed remote transaction processing features. The communications terminal 110 may comprise a cellular telephone device, for example, wherein the disclosed functionality is incorporated within the device in order to facilitate remote transactions. Moreover, practitioners will appreciate that the terms “communications terminal”, “communications device”, “remote terminal”, “wireless terminal”, “credit card terminal”, “POS terminal”, “card reader”, and any variation thereof may be used interchangeably without departing from the scope of the invention.

In addition, it should be noted that although the invention is described with respect to a communication terminal 110, the invention is not so limited. The invention is suitable for any device or instrument capable of accepting, formatting, and transmitting distinct data sets. These data sets may be provided by multiple distinct entities, where the distinct data sets may be formatted, one different from another. The data sets may correspond to an account comprising, for example, a calling card, a loyalty, debit, credit, incentive, direct debit, savings, financial, membership account or the like. While the information provided by the account issuers may be described as being “owned” by the issuers, the issuers or their designees may simply be a manager of the account.

The communications terminal 110 may take various forms. For example, the communications terminal 110 may be connected via any means known in the art to one or more variously located card readers 105. However, the functionality of the communications terminal 110 and the card reader 105 may reside within a single device. While described herein as two distinct devices (i.e., a communications terminal and a card reader), practitioners will appreciate that any number of hardware and/or software architectures, configured to facilitate the disclosed functionality, may be combined in any manner without departing from the scope of the invention.

As used herein, the terms “user,” “end user,” “consumer,” “customer”, “cardholder”, “accountholder”, or “participant” may be used interchangeably with each other, and each shall mean any person, entity, machine, hardware, software, and/or business. Furthermore, the terms “business” or “merchant” may be used interchangeably with each other and shall mean any person, entity, machine, hardware, software, or business. Further still, the merchant may be any person, entity, software, and/or hardware that is a provider, broker, and/or any other entity in the distribution chain of goods or services.

Communication between various entities of the invention is accomplished through any suitable communication means, such as, for example, a telephone network, intranet, Internet, payment network (point-of-sale device, personal digital assistant, cellular phone, smart phone, appliance, kiosk, etc.), online communications, off-line communications, wireless communications, and/or the like. One skilled in the art will also appreciate that, for security reasons, any databases, systems, or components of the present invention may consist of any combination of databases or components at a single location or at multiple locations, wherein each database or system includes any of various suitable security features, such as firewalls, access codes, encryption, decryption, compression, decompression, and/or the like.

Wireless communication, described herein as occurring between the various wireless entities, is facilitated via a radio spectrum, which includes microwave frequencies divided into channels, each occupying a 30 kHz band. These channels may be either control or communications channels. Communication channels typically carry both voice and data content and operate at slightly higher frequencies than the voice and data channels. They command, control signaling inputs and outputs, and manage other network transmission functions.

A transaction device 150 (e.g., smart card, magnetic strip card, bar code card, optical card, biometric device, radio frequency fob or transponder and/or the like) may directly or indirectly communicate to the communications terminal 110, information from one or more data sets associated with the transaction device 150. In one example, membership data and credit card data associated with a transaction account or transaction device 150 may be transmitted using any conventional protocol for transmission and/or retrieval of information from an account or associated transaction device 150 (e.g., credit, debit, gift, stored value, loyalty, etc.). In yet another exemplary embodiment of the invention, a transaction device 150 may be an electronic coupon, voucher, and/or other such instrument. In one exemplary embodiment, the transaction device 150 may be configured to communicate via RF signals. As such, the data contained on the transaction device 150 may be communicated via radio frequency signals to the communications terminal 110.

Transactions that are invoked by the transaction device 150 may be used to execute payment for acquisitions, obtain access, provide identification, pay an amount, receive payment, redeem reward points, and/or the like. In the radio frequency (RF) embodiments of the communications terminal, transaction device to communications terminal 110 transactions may also be performed. See, for example, Sony's Near Field Communication (NFC) emerging standard operates on 13.56 MHz and allowing the transfer of any kind of data between NFC enabled devices and across a distance of up to twenty centimeters. See also, Bluetooth chaotic network configuration; described in detail at http://www.palowireless.com/infotooth/whatis.asp, which is incorporated herein by reference. Furthermore, data on a first NFC device 145 may be transmitted directly or indirectly to another NFC device 145 to create a copy of all or part of the original device.

The transaction device 150 may be associated with various applications, which allow the transaction device account owner to participate in various programs, such as, for example, loyalty programs. A loyalty program may include one or more loyalty accounts. Exemplary loyalty programs include frequent flyer miles, on-line points earned from viewing or purchasing products or websites on-line and programs associated with diner's cards, credit cards, debit cards, hotel cards, calling cards, and/or the like. Generally, the user is both the owner of the transaction account and the participant in the loyalty program; however, this association is not necessary. For example, a participant in a loyalty program may gift loyalty points to a user who pays for a purchase with his own transaction account, but uses the gifted loyalty points instead of paying the monetary value.

Moreover, a “code,” “account,” “account number,” “account code”, “identifier,” “loyalty number”, or “membership identifier,” as used herein, includes any device, code, or other identifier/indicia suitably configured to allow the consumer to interact or communicate with the disclosed communications terminal 110, such as, for example, authorization/access code, Personal Identification Number (PIN), Internet code, other identification code, and/or the like that is optionally located on a SIM card, rewards card, charge card, credit card, debit card, prepaid card, telephone card, smart card, magnetic strip card, bar code card, radio frequency card and/or the like. The account code may be distributed and stored in any form of plastic, electronic, magnetic, radio frequency, audio and/or optical device capable of transmitting or downloading data from itself to a second device. An account code may be, for example, a sixteen-digit credit card number, although each credit provider has its own numbering system, such as the fifteen-digit numbering system used by an exemplary loyalty system. Each company's credit card numbers comply with that company's standardized format such that the company using a sixteen-digit format may generally use four spaced sets of numbers, as represented by the number “0000 0000 0000 0000”. The first five to seven digits are reserved for processing purposes and identify the issuing bank, card type and etc. In this example, the last sixteenth digit is used as a sum check for the sixteen-digit number. The intermediary eight-to-ten digits are used to uniquely identify the customer. In addition, loyalty account numbers of various types may be used.

Moreover, the “transaction information” in accordance with this invention may include the nature or amount of transaction, as well as, a merchant, user, and/or issuer identifier, security codes, routing numbers, and the like. In various exemplary embodiments of the invention, one or more transaction accounts may be used to satisfy or complete a transaction. For example, the transaction may be only partially completed using the transaction account(s) correlating to the application tenant information stored on the transaction device 150 with the balance of the transaction being completed using other sources. Cash may be used to complete part of a transaction and the transaction account associated with a user and the transaction device 150, may be used to satisfy the balance of the transaction. Alternatively, the user may identify which transaction account, or combination of transaction accounts stored on the transaction device 150 the user desires to complete the transaction. Any known or new methods and/or systems configured to manipulate the transaction account in accordance with the invention may be used.

One skilled in the art will appreciate that a network may include any system for exchanging data or transacting business, such as the Internet, an intranet, an extranet, WAN, LAN, satellite communications, cellular network, and/or the like. It is noted that the network may be implemented as other types of networks such as, for example, an interactive television (ITV) network. The users may interact with the system via any input device such as a keyboard, mouse, kiosk, personal digital assistant (e.g., Palm Pilot™), handheld computer, cellular phone, and/or the like. Similarly, the invention may be used in conjunction with any type of personal computer, network computer, workstation, minicomputer, mainframe, or the like running any operating system such as any version of Windows, Windows XP, Windows Vista, Windows NT, Windows 2000, Windows 98, Windows 95, MacOS, OS/2, BeOS, Linux, UNIX, Solaris, or the like. Moreover, although the invention is frequently described herein as being implemented with specific communications protocols, it may be readily understood that the invention could also be implemented using IPX, AppleTalk, IP-6, NetBIOS, OSI or any number of existing or future protocols. Moreover, the system may contemplate the use, sale or distribution of any goods, services or information over any network having similar functionality described herein.

In one embodiment, application code resident on the communications terminal 110 is structured in accordance with the Open Systems Interconnect (OSI) reference model. As such, various “layers” are described herein; each configured to perform specific tasks. In general, a programming architecture built on the OSI reference model contains seven layers including a Physical Layer, Data Link Layer, Network Layer, Transport Layer, Session Layer, Presentation Layer, and Application Layer. A precise description of each layer is beyond the scope of this disclosure and reference to individual layers will be made only as they relate to the disclosed functionality. Practitioners will appreciate that any number of programming architectures could be employed to carry out the disclosed functionality without departing from the scope of the invention.

Reference is made herein to packet switching when describing the functionality of the invention relative to the management of transaction data. Transaction data includes, for example, transaction account data, transaction data, merchant data, etc. Specifically, packet switching is a means for economically sending and receiving data over alternate, multiple network channels. The premise for packet switching is the packet, which is a small bundle of information containing the payload and routing information. Packet switching accepts data, parses the data into packets, and transmits the packets to a defined destination. When traversing network adapters, switches, routers and other network nodes, packets may be buffered and queued, resulting in variable delay and throughput depending on the traffic load in the network.

The computing units described herein may be connected with each other via a data communication network 120. The network 120 may be a public network and assumed to be insecure and open to eavesdroppers. In the illustrated implementation, the network 120 may be embodied as the Internet. In this context, the computers may or may not be connected to the Internet at all times. For instance, a communications terminal 110 may employ a modem to occasionally connect to the Internet, whereas a host processing server computing center 140 might maintain a permanent connection to the Internet. Specific information related to the protocols, standards, and application software utilized in connection with the Internet may not be discussed herein.

The various systems may be suitably coupled to the network via data links. A variety of conventional communications media and protocols may be used for data links. For example, a connection to an Internet Service Provider (ISP) over the local loop as is typically used in connection with standard modem communication, cable modem, Dish networks, ISDN, Digital Subscriber Line (DSL), or various wireless communication methods. The communications terminal 110 might also reside within a local area network (LAN) that interfaces to the network via a leased line (T1, D3, etc.).

Any databases discussed herein may be any type of database, such as relational, hierarchical, graphical, object-oriented, and/or other database configurations. Common database products that may be used to implement the databases include DB2 by IBM (White Plains, N.Y.), various database products available from Oracle Corporation (Redwood Shores, Calif.), Microsoft Access or Microsoft SQL Server by Microsoft Corporation (Redmond, Wash.), or any other suitable database product. Moreover, the databases may be organized in any suitable manner, for example, as data tables or lookup tables. Each record may be a single file, a series of files, a linked series of data fields or any other data structure. Association of certain data may be accomplished through any desired data association technique such as those known or practiced in the art. For example, the association may be accomplished either manually or automatically. Automatic association techniques may include, for example, a database search, a database merge, GREP, AGREP, SQL, and/or the like. The association step may be accomplished by a database merge function, for example, using a “key field” in pre-selected databases or data sectors.

More particularly, a “key field” partitions the database according to the high-level class of objects defined by the key field. For example, certain types of data may be designated as a key field in a plurality of related data tables and the data tables may then be linked on the basis of the type of data in the key field. In this regard, the data corresponding to the key field in each of the linked data tables is preferably the same or of the same type. However, data tables having similar, though not identical, data in the key fields may also be linked by using AGREP, for example. In accordance with one aspect of the present invention, any suitable data storage technique may be utilized to store data without a standard format. Data sets may be stored using any suitable technique, including, for example, storing individual files using an ISO/IEC 7816-4 file structure; implementing a domain whereby a dedicated file is selected that exposes one or more elementary files containing one or more data sets; using data sets stored in individual files using a hierarchical filing system; data sets stored as records in a single file (including compression, SQL accessible, hashed via one or more keys, numeric, alphabetical by first tuple, etc.); block of binary (BLOB); stored as ungrouped data elements encoded using ISO/IEC 7816-6 data elements; stored as ungrouped data elements encoded using ISO/IEC Abstract Syntax Notation (ASN.1) as in ISO/IEC 8824 and 8825; and/or other proprietary techniques that may include fractal compression methods, image compression methods, etc.

In one exemplary embodiment, the ability to store a wide variety of information in different formats is facilitated by storing the information as a Binary Large Object (BLOB). Thus, any binary information may be stored in a storage space associated with a data set. As discussed above, the binary information may be stored on the financial transaction instrument or external to but affiliated with the financial transaction instrument. The BLOB method may store data sets as ungrouped data elements formatted as a block of binary via a fixed memory offset using fixed storage allocation, circular queue techniques, or best practices with respect to memory management (e.g., paged memory, least recently used, etc.). By using BLOB methods, the ability to store various data sets that have different formats facilitates the storage of data associated with the financial transaction instrument by multiple and unrelated owners of the data sets. For example, a first data set which may be stored may be provided by a first issuer, a second data set which may be stored may be provided by an unrelated second issuer, and yet a third data set which may be stored, may be provided by an third issuer unrelated to the first and second issuer. Each of these three exemplary data sets may contain different information that is stored using different data storage formats and/or techniques. Further, each data set may contain subsets of data, which also may be distinct from other subsets.

The data set annotation may be used for various types of status information as well as other purposes. For example, the data set annotation may include security information establishing access levels. The access levels may, for example, be suitably configured to permit only certain individuals, levels of employees, companies, or other entities to access data sets, or to permit access to specific data sets based on the transaction, merchant, issuer, user or the like. Furthermore, the security information may restrict/permit only certain actions such as accessing, modifying, and/or deleting data sets. In one example, the data set annotation indicates that only the data set owner or the user are permitted to delete a data set, various identified merchants are permitted to access the data set for reading, and others are altogether excluded from accessing the data set. However, other access restriction parameters may also be used allowing various entities to access a data set with various permission levels as appropriate.

One skilled in the art will also appreciate that, for security reasons, any databases, systems, devices, servers or other components of the present invention may consist of any combination thereof at a single location or at multiple locations, wherein each database or system includes any of various suitable security features, such as firewalls, access codes, encryption, decryption, compression, decompression, and/or the like.

The present invention may be described herein in terms of functional block components, optional selections and/or various processing steps. It should be appreciated that such functional blocks may be realized by any number of hardware and/or software components suitably configured to perform the specified functions. For example, the present invention may employ various integrated circuit components, e.g., memory elements, processing elements, logic elements, look-up tables, and/or the like, which may carry out a variety of functions under the control of one or more microprocessors or other control devices. Similarly, the software elements of the present invention may be implemented with any programming or scripting language such as C, C++, Java, COBOL, assembler, PERL, Visual Basic, SQL Stored Procedures, extensible markup language (XML), Microsoft.Net with the various algorithms being implemented with any combination of data structures, objects, processes, routines or other programming elements. Further, it should be noted that the present invention may employ any number of conventional techniques for data transmission, messaging, data processing, network control, and/or the like. Still further, the invention could be used to detect or prevent security issues with a client-side scripting language, such as JavaScript, VBScript or the like. For a basic introduction of cryptography and network security, the following may be helpful references: (1) “Applied Cryptography: Protocols, Algorithms, And Source Code In C,” by Bruce Schneier, published by John Wiley & Sons (second edition, 1996); (2) “Java Cryptography” by Jonathan Knudson, published by O'Reilly & Associates (1998); (3) “Cryptography & Network Security: Principles & Practice” by Mayiam Stalling, published by Prentice Hall; all of which are hereby incorporated by reference.

It should be appreciated that the particular implementations shown and described herein are illustrative of the invention and its best mode and are not intended to otherwise limit the scope of the present invention in any way. Indeed, for the sake of brevity, conventional data networking, application development and other functional aspects of the systems (and components of the individual operating components of the systems) may not be described in detail herein. It should be noted that many alternative or additional functional relationships or physical connections might be present in a practical transaction instrument distribution system.

As may be appreciated by one of ordinary skill in the art, the present invention may be embodied as a method, a data processing system, a device for data processing, a financial transaction instrument, and/or a computer program product. Accordingly, the present invention may take the form of an entirely software embodiment, an entirely hardware embodiment, or an embodiment combining aspects of both software and hardware or other physical devices. Furthermore, the present invention may take the form of a computer program product on a tangible computer-readable storage medium having computer-readable program code means embodied in the storage medium. Any suitable tangible computer-readable storage medium may be utilized, including hard disks, CD-ROM, optical storage devices, magnetic storage devices, and/or the like.

These computer program instructions may also be stored in a computer-readable memory that may direct a computer or other programmable data processing apparatus to function in a particular manner, such that the instructions stored in the computer-readable memory produce an article of manufacture including instruction means which implement functions of flowchart block or blocks. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus include steps for implementing the functions specified in the flowchart block or blocks.

In addition to the communications terminal 110, the user, merchant, or other entity may be equipped with a computing unit 115 to configure features of the communications terminal 110 and/or facilitate transactions. For example, the merchant may have a computing unit 115 in the form of a personal computer, although other types of computing units may be used including laptops, notebooks, hand held computers, set-top boxes, and/or the like. The merchant computer may have a computing unit 115 implemented in the form of a computer server, although other implementations are possible. A processor gateway, host processing server 140, or other entity may have a computing center such as a mainframe computer. However, the host processing server computing center may be implemented in other forms, such as a mini-computer, a PC server, a network set of computers, or the like.

Communications terminal 110 employs wireless capabilities similar to those found in other known wireless devices such as, for example, cellular telephones, notebook computers, personal digital assistants, and the like. As such, communications terminal 110 is able to communicate with a network 155 via a wireless base station 130. In accordance with present wireless communications technology, the base station 130 exchanges RF signals with the communications terminal 110 by way of a network of radio towers 125 (i.e. cellular network).

Various voice and data communications protocols are used in the facilitation of the wireless communications described herein. Such protocols include, for example, Time Division Multiple Access (TDMA), Code Division Multiple Access (CDMA), Wide-CDMA (W-CDMA), Evolution-Data Optimized (EV-DO), Protocol Handling Server (PHS), wireless Local Access Network (LAN), infrared wireless, etc. TDMA and CDMA are the two most prevalent second-generation protocols for digitizing communications in order to facilitate wireless data transmission. Bandwidth for TDMA and CDMA is generally allocated in the 800 MHz, 900 MHz, and 1900 MHz ranges. Practitioners will appreciate that the protocols and protocol bandwidths discussed herein are for explanation only and are not intended to limit the scope of the invention. Other presently known and future wireless protocols may be equally and similarly utilized to facilitate the wireless transaction functionality described herein.

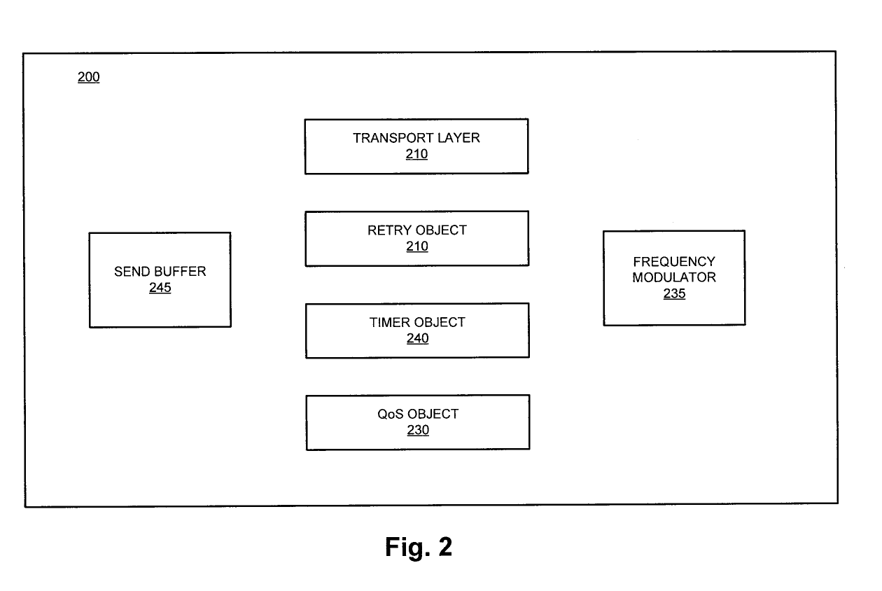

Referring to FIG. 2 with further reference to FIG. 1, application code defining the disclosed retry logic may reside as a Session Layer 205 service of the communications terminal 200. The Session Layer 205 provides the mechanism for opening, closing, and managing sessions between disparate application processes running at the communications terminal 200. In other words, the disclosed retry logic may reside as a middleware component (Retry Object 225) that manages communication sessions. Communication sessions comprise requests and responses that occur between applications. The Retry Object 225 of the invention communicates with any number of applications running on the communications terminal 200, but in particular, maintains open communication with a timer object 240 and protocol manager 235 of the communications terminal 200.

Typical, information from the transaction device 150 is entered into the card reader 105. This can be facilitated by any means known in the art including, for example, sliding a credit card through a magnetic strip reader of the card reader 105, keying payment account information directly into the communications terminal 110, reading account information from a smart card chip, and the like. In one embodiment, the card reader 105 is equipped with physical data storage for maintaining transaction device 150 data such that the data can be queued and sent to the communications terminal 110 when a connection is confirmed. For example, a merchant may utilize an NFC-based portable card reader 105 that is physically independent from the communications terminal 110. If a communication channel between the card reader 105 and the communications terminal 110 is temporarily unavailable, the card reader 105 stores the transaction device 150 information in the physical data storage until the communications channel is available; at which time, the information is sent to the communications terminal 110.

When the information is received at the communications processor 200, the information is formatted into a transaction request packet. A send buffer 245 stores the packet destined for a processing gateway 135 until it can be sent, so as to prevent data loss. If the communications terminal 200 accesses the processing gateway 135 through dial-up or flow access, the communications terminal 200 creates a timer object 240, attempts to establish a connection to the network 120, and sends the information in the send buffer 245 to the processing gateway 135 when the timer object 240 expires. If an access interface is down or a connection from the communications terminal 200 is terminated, the corresponding send buffer 245 is cleared, that is, all packets in the send buffer 245 are discarded.

Due to QoS variances in wireless communications as described above, a number of methods have been introduced to ensure that a transaction can be economically facilitated, from invocation to completion. One such method includes a simple retry algorithm that is programmed into the communication terminal 200. In its simplest form, this logic sets forth rules that cause the communications terminal 200 to repeatedly attempt to establish a communications channel with a processing gateway 135 via a radio tower 125 until a quality connection is established. Such systems are conventionally programmed to retry the connection attempt at regular intervals. The retry attempts are terminated when a timeout expires and no connection has been made.

In one embodiment, the communications terminal 110 is configured with more complex retry logic that comprises rules that enable the communications device 110 to switch from a first communication protocol to a second communication protocol when one or more connection establishment attempts fail. As such, the terminal may include a default protocol selection and multiple secondary protocols to use should a connection with the default protocol fail. Moreover, the communications terminal 110 may include a frequency modulator 235 to modify a communications channel to a secondary frequency upon invocation from the Retry Object 225. Modulation ranges may be defined in addition to rules governing events and timeframes that should trigger a real-time modification to frequency parameters.

For simplicity, FIG. 2 makes reference to a single component (i.e. modulator 235) that is tasked with modifying either the communications protocol or modulating the communication frequency. Practitioners will appreciate that these tasks may be performed by two disparate components that are controlled, either directly or indirectly, by any of the objects and/or layers described herein. However, it should be understood that the controlling object or layer receives its instructions from the Retry Object 225 as described herein.

When a QoS exceeds a defined threshold value, the communications terminal 200 establishes a network connection with processing gateway 135 and sends a transaction request to the processing gateway 135. The transaction request may comprise the account information, merchant identity information, and transaction information. Based on the information in the transaction request, the processing gateway 135 formats the request and routes it to an appropriate host processing server 140. The host processing server 140 verifies the account information and determines whether an account corresponding to the account information has funds available in an amount sufficient to authorize the transaction. The host processing server 140 compiles a response message and sends it back to the payment gateway 135, which routes the response message back to the communications terminal 110.

As those of ordinary skill in the art will appreciate, the communications terminal 110 may exist as a hardware component suitably configured to read a transaction device 150, format a transaction request, and transmit the request to a processing gateway 135. However, the functionality of the communications terminal 110 as described above may take the form of a software configuration residing at, or accessible by a personal computer, handheld device, cellular telephone, and the like.

For a more complete understanding of the disclosed invention, a focused description of the above process is presented herein. The following description includes examples of various embodiments; wherein the disclosed Retry Object 225 functionality is achieved. Specific attention is given to the Retry Object 225 as being representative of the invention. Various components contribute to the inventive features of the Retry Object 225; however, practitioners will appreciate that the disclosed functions are given weight over the arrangement of the components performing the functions. For example, while it as known that the OSI reference model includes seven specific layers; each performing very specialized functions, the description herein is not so limited. In other words, the functionality that is normally associated with a first layer may be described as being performed by a second layer.

When the card reader 105 receives transaction account data from the transaction device 150, the read data is sent to the communications terminal 110 where it is received as transmitted data. In one embodiment, the communications terminal 110 includes a send buffer for storing transaction account data until such time that they can be transmitted to the communications terminal 110. Accordingly, the card reader 105 creates a timer object and sends transaction account data stored in the card reader 105 send buffer to the communications terminal 110 upon expiration of the timer object. If an access interface is not accessible or a TCP connection to the communications terminal 110 is terminated, the corresponding terminal send buffer is cleared. In other words, all packets residing in the card reader 105 send buffer are discarded.

The transaction account data is transmitted from the card reader 105 to the communications terminal 110 in accordance with any present or future wireless packet data transmission standard that is employed by the communications terminal 110. The data packet standard may include, for example, the General Packet Radio Service (“GPRS”). However, practitioners will appreciate that the data packet may be transmitted to the communications terminal 110 by any known standard.

In one embodiment, communications terminal 110 may employ the Transport Layer 210 to manage the transmission of packet data. The Transport Layer 210 controls the reliability of a given link through flow control, segmentation/de-segmentation, and error control. Some protocols are state and connection oriented, meaning that the Transport Layer 210 is able to track the segments and retransmit those that fail.

When the send buffer 245 of the communications terminal 200 contains one or more transaction data packets, a QoS Object 230 is invoked to determine the quality of a network link and report that information to a Retry Object 225. The Retry Object 225 is operable to employ a specified retry policy for the delivery of packets over the network link based on the quality of the link as determined by the QoS Object 230. Practitioners will appreciate that there are a number of known systems and methods for measuring signal quality and strength. For example, communications terminal may “ping” the processing gateway 135 in order to solicit a response from the gateway server. Determination may be made based on the response whether the quality of both the broadcast message and received response meets a defined QoS value. In another example, a listener module of the communications terminal 200 may detect RF signals that are regularly transmitted from cell phone towers. The quality of the RF signal can be ascertained using any number of known algorithms.

As used herein, “retry policy” refers to rules governing the behavior of the communications terminal 200 in response to a QoS value that falls within a defined threshold value. As such, the communications terminal 200 includes a memory portion for maintaining variable values. A user, by way of a communications terminal interface, may define the retry policy, comprising the variable values. In another embodiment, the communication terminal 200 may be configured by way of a connection with a computing unit, wherein a user interacts with an application interface of the computing unit to set values defining the retry policy.

In one embodiment, the retry policy states behavioral attributes relating to connection attempt origination times, durations, and failure states. When a data packet is resident in the send buffer 245, the retry policy is queried to determine how to establish a network link. Because the retry policy is updated in real-time based on the most recent link establishment attempt, the consecutive connection attempt is configured based on pre-established rules and on the conditions present during the most recent connection attempt. To conserve resources, the communications terminal may create a timer object with a greater wait time than the previously created timer object 240. This enables the communications terminal 200 to invoke fewer connection attempts when the signal quality and the likelihood of obtaining a meaningful connection are poor.

In another embodiment, the retry policy sets forth criteria for selecting a communication protocol best suited for transmitting a data packet over a network. Based on the most recent connection attempts, the Retry Object 225 determines a connection protocol best suited for a connection attempt at the present moment and under the current conditions. The Retry Object 225 may further maintain information relating to trends, and based on statistical trend analysis, determine a network protocol that will likely result in a successful connection attempt.

In additional embodiments, the effects of time and conditions may result in modification of a combination of connection parameters, time based retry attempts, communications protocols, and frequency modulation procedures.

If the communications terminal 200 successfully established a link to the processing gateway 135, statistics describing the establishment of the connection are maintained for use in future connection attempts. For example, information noting that a link was established following three consecutive failed attempts; each being separated by a four-second pause between attempts is stored in the communication terminal's memory. This information is subsequently used to set the duration of a pause between retry attempts to eight seconds (i.e. four second between the first failed attempt and the second failed attempt plus four seconds between the second failed attempt and the successful connection). As such, the next data packet may require fewer connection attempts and therefore conserve the battery power for the mobile credit card terminal.

In the foregoing specification, the invention has been described with reference to specific embodiments. However, it may be appreciated that various modifications and changes may be made without departing from the scope of the present invention. The specification and figures are to be regarded in an illustrative manner, rather than a restrictive one, and all such modifications are intended to be included within the scope of present invention. Accordingly, the scope of the invention should be determined by the appended claims and their legal equivalents, rather than by the examples given above. For example, the steps recited in any of the method or process claims may be executed in any order and are not limited to the order presented.

Moreover, the forgoing description describes present various embodiments of the present invention; however are not intended to limit the scope of the invention in any way. Those of ordinary skill in the art will appreciate that the disclosed components, including hardware and software, may be arranged in various manners to accommodate the disclosed functionality. The benefits disclosed herein are realized through any number of configurations of the discussed software and/or hardware components.

Benefits, other advantages, and solutions to problems have been described above with regard to specific embodiments. However, the benefits, advantages, solutions to problems, and any element(s) that may cause any benefit, advantage, or solution to occur or become more pronounced are not to be construed as critical, required, or essential features or elements of any or all the claims. As used herein, the terms “comprises”, “comprising”, or any other variation thereof, are intended to cover a non-exclusive inclusion, such that a process, method, article, or apparatus that comprises a list of elements does not include only those elements but may include other elements not expressly listed or inherent to such process, method, article, or apparatus. Further, no element described herein is required for the practice of the invention unless expressly described as “essential” or “critical”.

What is claimed is:

1. A computer-implemented method for dynamically configuring connectivity logic associated with a networked device, said method comprising:
determining, by said networked device, a quality of service value for a network connection first attempt;
retrieving, by said networked device, a quality of service threshold;
comparing, by said networked device, said quality of service value to said quality of service threshold to create a connection state;
retrieving, by said networked device, at least one of: a connection attempt time interval, a network protocol, and a modulation parameter corresponding to said connection state; and
modifying at least one of: said connection attempt time interval, said network protocol, and said modulation parameter; and
invoking, by said networked device, a network connection second attempt in accordance with at least one of: said connection attempt time interval, said network protocol, and said modulation parameter.

2. The computer-implemented method of claim 1, wherein said network connection first attempt includes one or more failed connection attempts.

3. The computer-implemented method of claim 1, wherein said at least one of: said connection attempt time interval, said network protocol, and said modulation parameter are stored in a memory structure of said networked device.

4. The computer-implemented method of claim 1, wherein said quality of service value is indicative of at least one of: signal strength and signal noise.

5. The computer-implemented method of claim 1, wherein said networked device is a merchant Point of Sale terminal.
